(19) United States
(12) Patent Application Publication
(10) Pub. No.: US 2004/0177241 A1
(43) Pub. Date: Sep. 9, 2004

(54) Booting method that detects memory modes

(76) Inventors: Chih-Wei Chen, Taipei (TW); Yung-Po Chang, Taipei (TW)

Correspondence Address: BIRCH STEWART KOLASCH & BIRCH, PO BOX 747, FALLS CHURCH, VA, 22040-0747, US

(21) Appl. No.: 10/377,691

(22) Filed: Mar. 4, 2003

(51) Int. Cl. G06F 15/177

(52) U.S. Cl. 713/2

(57) ABSTRACT

A booting method that detects memory modes is applied to a computer-based platform. A dual insertion model is used to extract memory initial data. The system then performs a determination process for installation data and setting the reading mode. The installation data and reading mode are used to update the stored information in the BIOS, and then accomplish the booting procedure of the BIOS. This method enables the computer to operate using different types of memory.

### BACKGROUND OF THE INVENTION

1. Field of Invention

The invention relates to a booting method that detects memory modes and, in particular, to a method of detecting different types of memory at the same time as the BIOS performs the booting procedure.

2. Related Art

With the advance in modern technology, the functions of computers bring us great convenience. As the prices of computer products get lower, they have been widely accepted by the public. In order to further enhance the functions, various components inside the computer have undergone different progresses. In particular, increasing the working frequency of memory has been a primary development direction in the computer industry. Along with the development, various kinds of specifications have been proposed.

Basically, memory can be categorized into two types: the random access memory (RAM) and the read only memory (ROM). The difference between them is that the system can only passively read data in the latter but can arbitrarily read and write data in the former. However, the RAM has to be supplied with a constant electrical power in order to keep the data. Once the power is discontinued, the data stored therein also disappear. We observe many types of RAM on the market, including the fast page mode dynamical RAM (FPDRAM), the extended data out (EDO) DRAM, the synchronous DRAM (SDRAM), and double data rate (DDR) SDRAM. In accord with different types of memory, the slots on the main board also have different types, such as the single in-line memory module (SIMM) and the dual in-line memory module (DIMM).

For different memory modes, the reading methods have different restrictions. In the conventional booting procedure, the basic input/output system (BIOS) takes charge of the initialization of various peripheral devices of the computer so that the operating system (OS) can control and monitor all the devices. In particular, the memory setting is usually such that only memory of the same type is allowed. In other words, when two or an even multiple sets of memory are used, they have to be of the same type. As a result, it is inconvenient and expensive when one wants to replace the computer internal memory to another type.

### SUMMARY OF THE INVENTION

To solve the above problem, the invention provides a booting method that detects memory modes. A primary objective is to enable the BIOS to dynamically detect memory modes and to initialize them, thereby completing the booting procedure. There is no restriction of using the same mode of memory or no need to manually set jumps on the main board.

To achieve the above objective, the disclosed method include the steps of: starting the BIOS; using a chipset (such as the south bridge chipset) on the main board to communicate with peripheral device (such as hard disk drives and extended cards); using the north bridge chipset to set and communicate with the central processing unit (CPU) and the accelerated graphic port (AGP); completing the BIOS booting procedure and entering the operating system (OS). It should be noted that the BIOS detects the memory modes and uses the detected information to update the data stored in the BIOS. Finally, the north bridge chipset sets the read/write (RW) mode of the memory.

The disclosed method utilizes the BIOS to perform the procedure of extracting initialization information of memory, to determine data installation, and to set the reading mode. Therefore, the computer system can operate using different types of memory, increasing the values of memory. In addition, there is no need to manually set the jumps.

### BRIEF DESCRIPTION OF THE DRAWINGS

The invention will become more fully understood from the detailed description given hereinbelow illustration only, and thus are not limitative of the present invention, and wherein:

FIG. 1 is a system structure of the disclosed booting method that detects memory modes;

FIG. 2 is a flowchart of the disclosed method; and

FIG. 3 is a flowchart of the information extraction process according to the invention.

### DETAILED DESCRIPTION OF THE INVENTION

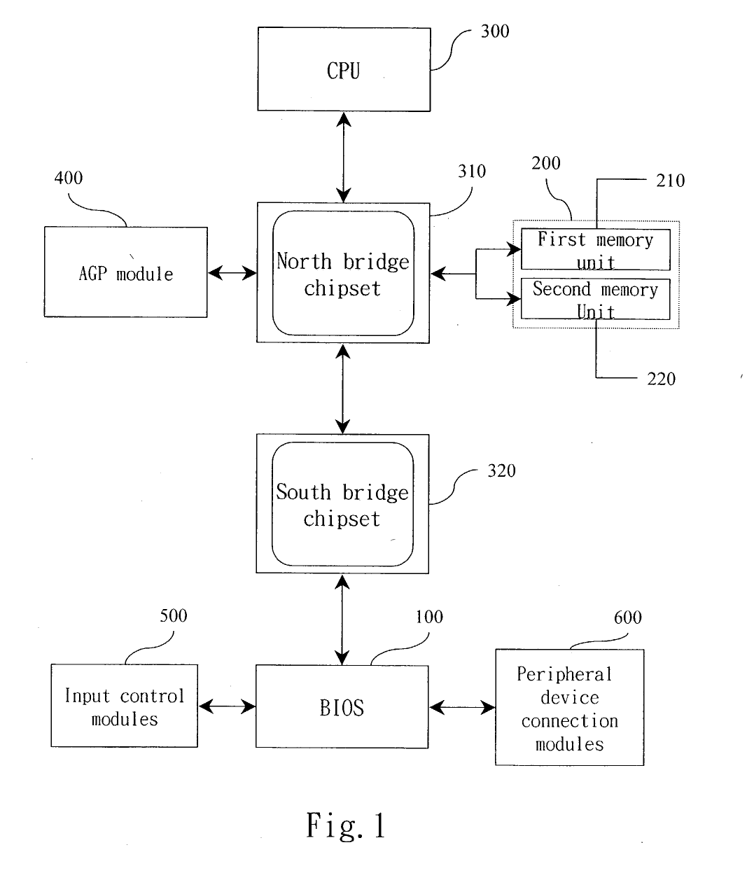

A booting method that detects memory modes disclosed by the invention is used in a computer-based platform. Through the real-time memory mode detection, the BIOS is dynamically tuned to incorporate the detected information, thereby completing the booting procedure. We use FIG. 1 is explain the system structure of the invention.

The system is mainly comprised of the following elements:

(1) A BIOS 100. It stores and provides booting information needed for every module.

(2) A south bridge chipset 320. It communicates with peripheral device connection modules 600, such as all kinds of interface cards and peripheral devices (network cards, sound cards, hard disk drives, etc) and input control modules 500, such as the basic external input devices (keyboard, mouse, etc).

(3) A north bridge chipset 310. It sets and links to the AGP module 400, and links and drives the memory module 200. The memory module 200 contains a first memory unit 210 and a second memory unit 220.

(4) A CPU 300. All modules send information to the CPU 300 for further data processing and operations.

It should be noted that the memory module 200 is used to temporarily store information transmitted from the peripheral devices and to rapidly provide information required by the CPU 300.

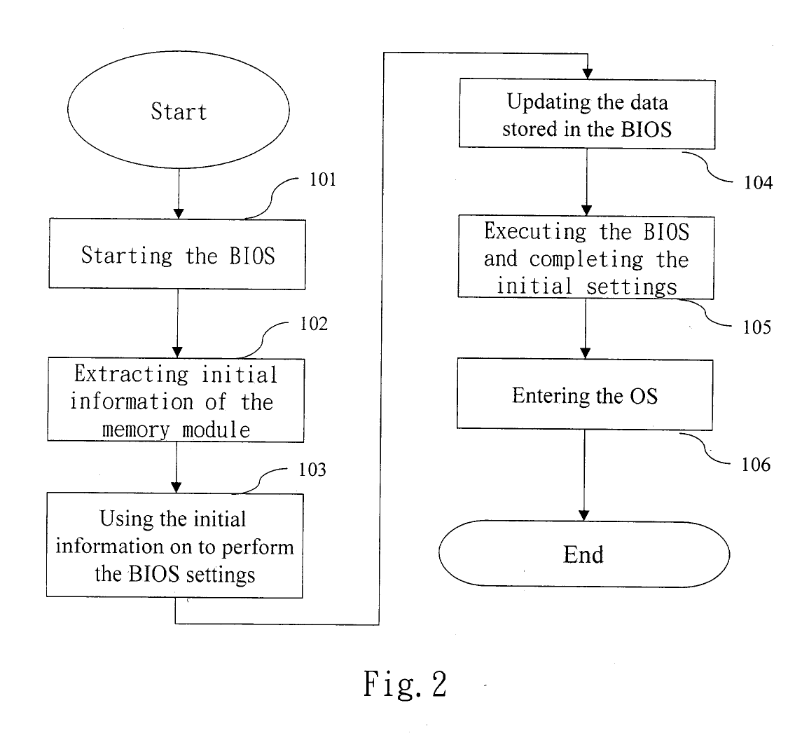

With reference to FIG. 2, the disclosed method includes the steps of starting the BIOS 100 (step 101); extracting initial information of the memory module 200 (step 102); using the initial information to perform the BIOS settings (step 103); updating the data stored in the BIOS (step 104); executing the BIOS 100 and completing the initial settings (step 105); and entering the OS(Operation System) (step 106).

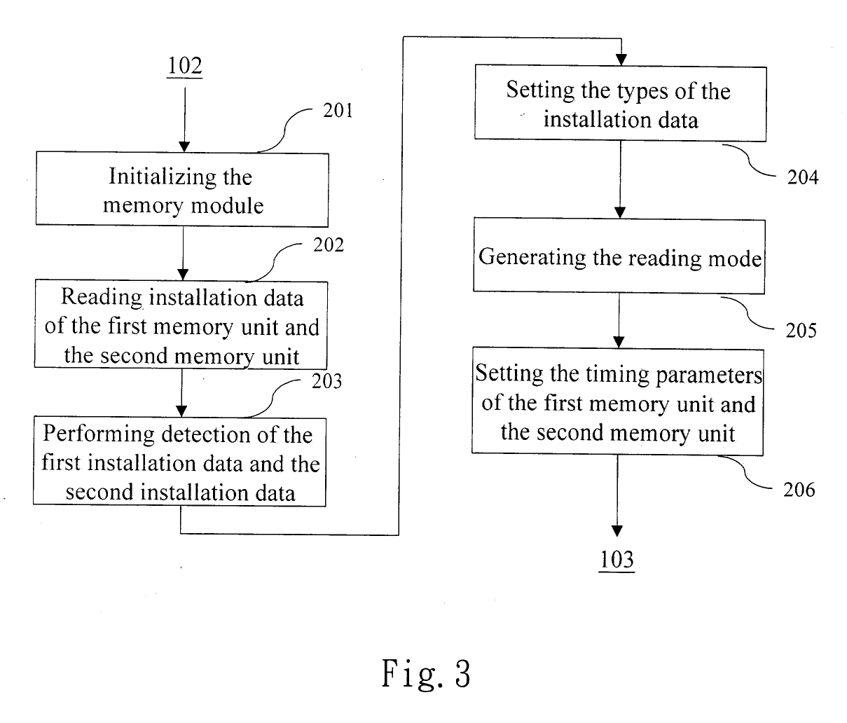

The steps of extracting initial information can be explained in further detail using FIG. 3. It includes the steps of: initializing the memory module (step 201); reading installation data of the first memory unit and the second memory unit (step 202); performing detection of the first installation data and the second installation data (step 203), where the first installation data and the second installation data are numbers; setting the types of the installation data (step 204) to be single-sided or double-sided; and generating the reading mode (step 205) to be the interleave mode or the non-interleave mode; and setting the timing parameters of the first memory unit and the second memory unit (step 206).

Certain variations would be apparent to those skilled in the art, which variations are considered within the spirit and scope of the claimed invention.

What is claimed is:

1. A booting method that detects memory modes for dynamically tuning BIOS (basic input/output system) settings through real-time memory mode detection on a computer-based platform to complete the booting procedure, the method comprising steps of:
starting the BIOS;
performing an operation to extract initial information a memory module;
using the initial information to set the BIOS;
executing the BIOS; and
entering the OS (operating system).

2. The method of claim 1, wherein the memory module further comprises a first memory unit and a second memory unit.

3. The method of claim 2, wherein the first memory unit and the second memory unit are associated with first installation data and second installation data, respectively.

4. The method of claim 3, wherein the first installation data and the second installation data are selected from the group consisting of single-sided and double-sided forms.

5. The method of claim 3, wherein the first installation data and the second installation data are numbers.

6. The method of claim 3, wherein the operation to extract initial information further comprises the steps of:
reading the first installation data and the second installation data of the first
memory unit and the second memory unit, respectively;
detecting the first installation data and the second installation data;
generating a reading mode; and
setting a timing parameter.

7. The method of claim 6, wherein the reading mode is selected from the group consisting of the interleave mode and the non-interleave mode.

8. The method of claim 1, wherein the step of using the initial information to set the BIOS further includes the step of initializing the memory module.
